(19) United States
(12) Patent Application Publication
(10) Pub. No.: US 2009/0022924 A1
(43) Pub. Date: Jan. 22, 2009

(54) Roofing patch

(76) Inventor: Christopher J. Griffin, Aurora, CO (US)

Correspondence Address: JOHNS MANVILLE, 10100 WEST UTE AVENUE, PO BOX 625005, LITTLETON, CO, 80162-5005, US

(21) Appl. No.: 11/879,425

(22) Filed: Jul. 17, 2007

(51) Int. Cl. B32B 9/00; B29C 65/00

(52) U.S. Cl. 428/40.2; 156/60

(57) ABSTRACT

Provided is a patch for a roofing membrane and a method of applying same. The patch is comprised of a substrate compatible with the roofing membrane, which has encapsulated adhesive on the side to be applied to the roofing membrane. When the patch is applied to the roofing membrane with pressure, the adhesive, encapsulated in cells, is released upon rupture of the cells. The patch is thereby easily and quickly applied to effect a desired seal or repair.

### BACKGROUND OF THE INVENTION

1. Field of Art

The present invention relates to a roofing patch. More specifically, the present invention relates to a roofing patch which is effectively self-adhering and is useful for repairs and sealing “T-joints”.

2. Description of the Related Art

Conventional single ply and modified bitumen roof coverings or membranes, in use since 1970, have experienced several problems involving ease of installation, poor light reflectivity resulting in higher energy costs, and shrinkage resulting in seam failure, low tolerance of cold temperatures causing cracking and loss of flexibility and lower adhesive resistance to chemical attack. All resulting in the need for replacement and/or repair. Conventional roofing employing single ply sheets of ethylene/propylene/butadiene (EPDM) copolymers have experienced leakage and seam failure due to membrane shrinkage. The introduction of seam tapes replacing adhesives have partially ameliorated this condition; however, the application of tapes is time consuming and encounters difficulties in repair and replacement. In general, all single ply and modified bitumen roofs may need repair patches due to seam, lap or joint failure, cracking, mechanical damage, foot traffic, etc.

Ease of repair is a key requirement for any roofing membrane. The addition of rooftop equipment, mechanical damage from natural forces or human error can necessitate a repair to even the best roofing system. Accordingly, single ply and modified bitumen roofs at time will need repair, known as “patching”. New methods for patching such roof systems that are both easy and inexpensive as well as providing a patch that is as strong as the original membrane is required for membrane roof systems.

Single ply and modified bitumen roofing membranes (mechanically-attached or fully-adhered), as well as self-adhered SBS systems often require patches to be placed on “T-joints” to insure the joint stays watertight. Also, all roof systems sometimes need patches to be applied when repairs are made, or for additional penetrations etc. Such patches exist, but need labor to either hot-weld them, mix and apply adhesive, or hot asphalt, or torches. Sometimes T-joints or laps are caulked, which again requires additional labor and attention to detail.

U.S. Pat. No. 7,101,598 discloses a self adhering membrane for roofing application. The self adhering membrane includes a water impermeable membrane, a pressure sensitive, hot melt adhesive adhered to one side of the water impermeable membrane, and a release liner on the side of the pressure sensitive adhesive opposite the water impermeable membrane. The single ply self adhering roofing membrane is joined to the roof substrate by removing the release liner and then pressing the side of the membrane with the adhesive directly onto the roof substrate. How one would repair the membrane or seal a joint or seam is not discussed.

Accordingly, it is an object of the present invention to provide a patch for a roofing membrane which is quick, reliable and requires minimal tools and materials.

### SUMMARY OF THE INVENTION

Provided is a patch for a roofing membrane, which comprises a substrate for application to the roofing membrane, with the substrate containing encapsulated adhesive on the side to be applied to the roofing membrane. The adhesive is encapsulated in rupturable cells which will rupture to release the adhesive when pressure is applied. The cells in which the adhesive is encapsulated preferably comprise multiple bubbles or multiple ribbons. Most preferably, the substrate of the patch is made from the same material as the initial roofing membrane, e.g., EPDM patch with EPDM compatible adhesive to repair an EPDM roof.

Also provided is a method of applying a patch to a roofing membrane, which comprises first providing the patch of the present invention, applying the patch to the desired portion of the roofing membrane, and applying sufficient pressure to the patch to rupture the cells containing the adhesive to thereby release the adhesive. The pressure can be applied with a tool, such as a roller, or simply by manual pressure.

Among other factors, the present invention provides a patch which allows quick, reliable patching for repairs, and for sealing seams and/or T-joints. By encapsulating the adhesive, which is compatible with the patch and the roofing membrane to form a good bond, in rupturable cells, the patch can be stored and easily applied when and where desired by simply applying the patch with pressure. Application of pressure ruptures the cells to thereby allow the release of the adhesive. The adhesive flows to fill-in all channels, holes, gaps, etc., which could provide sites for water ingression. The patch can be cut to the desired shape and size, and minimal tools and materials are required for its application.

### BRIEF DESCRIPTION OF THE FIGURES OF THE DRAWINGS

FIG. 1 illustrates a top view of a patch in accordance with the present invention.

FIGS. 2A and 2B illustrate bottom views of two different embodiments of the present invention.

### DETAILED DESCRIPTION OF THE PREFERRED EMBODIMENTS

The patch can be made of any standard roofing membrane material (e.g. SBS, PVC, TPO, EPDM etc), but preferably is of the same material as the roof membrane being patched. The patch can be any size or shape, the most commonly used are, for example, 8″×8″ or 12″×12″, but they can be different sizes and do not need to be square. For example, an elongated rectangular patch may be used to patch along a seam. The patches can also be circular.

If this patch is used as a “target” to go over an extending member on the roof, for example, a round roof vent penetration, the patch may have a hole in the center to go over the penetration.

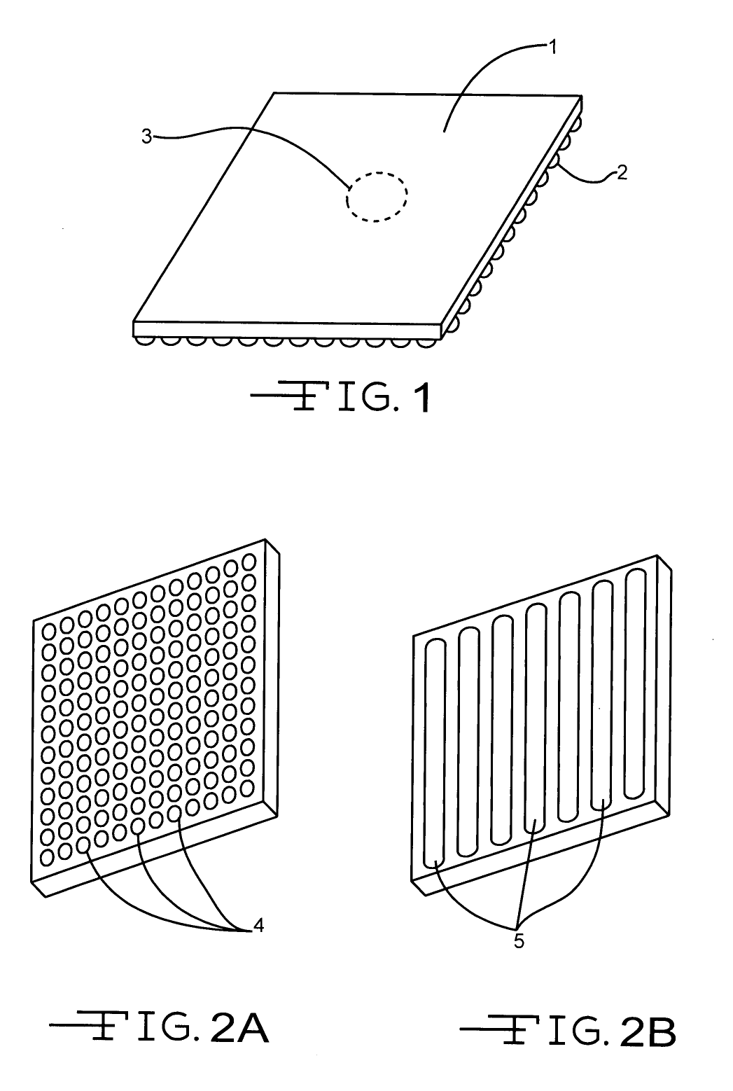

Referring to FIG. 1, the patch 1 is depicted from a top or aerial view. Rupturable cells 2 containing adhesive is shown on the bottom side of the patch. Optimally, a hole 3 can exist in the patch if the patch is to accommodate on extending member which exists on the roof, e.g., a vent. The extending member would penetrate the hole 3 and allow the patch to then seal around it once applied to the roofing membrane. The application of the patch can be used to simply seal around an extending member such as a vent, or can be used to repair the roofing membrane in the vicinity of the extending member.

The underside of the patch, the side which will be bonded to the existing roofing membrane, contains adhesive encapsulated in rupturable cells, for example, in small bubbles. The cells may be made of plastic, such as polyethylene, but any suitable materials will work, as long as it ruptures relatively easily to release the adhesive when pressure is applied, and does not react or degrade when in contact with the adhesive. Preferably, the adhesive is in discrete bubbles, or may be in ribbons along the patch, as shown in FIG. 2.

In FIGS. 2A and 2B, two different embodiments are shown for encapsulating the adhesive in different sized cells. In FIG. 2A, the cells 4 are bubble shaped. The bubbles cover the entire patch bottom in the figure, but the number of cells or bubbles can be adjusted as needed. Cells only in the corners, for example, can be employed, or cells in the middle and each corner can be employed. Any suitable design of cells to ensure proper adhesive coverage can be used. In FIG. 2B, the cells 5 are layer and ribbon shaped. The number of such ribbons and their positions on the bottom side of the patch can be varied as needed or desired. The size and shape of the cell or cells can also be varied greatly. FIGS. 2A and 2B give only two preferred embodiments of the any alternatives available.

Each cell of adhesive may contain the same adhesive, which bonds the patch to the membrane. The adhesive may need to be different depending on the patch materials and the roofing membrane material. For example, for SBS systems, an adhesive used for bonding SBS adhesive will need to be used, or a TPO adhesive for TPO membranes. Alternatively, a 2-part adhesive may be used, where some bubbles will contain the part A adhesive and some of the part B. The ratio of A and B, or the size of the bubbles, will insure that the correct amounts of A and B are mixed.

On an area or T-joint or lap which needs to be patched, the patch of the appropriate size, either pre-cut or cut to size on the roof, or a hold cut in for a penetration, would be placed over the area and pressure applied on top, either by a roller or even by standing on the patch. This pressure would burst the bubbles enabling the adhesive to flow and bond the patch to the surface of the roofing membrane. Enough adhesive would be released to flow into any areas difficult to access, for example, into laps, T-joints, or even to flow around a granulated roofing surface ensuring the patch is completely watertight.

The roofing contractor would need only to take some patches onto the roof, maybe a roller and maybe a knife or scissors, to cut the patch to the desired size. The patch could be applied quickly and easily, saving time labor and insuring a leak-proof patch. Also, no solvents, applied adhesives, open flames, hot asphalt, etc. is needed or used in the simple application of the roof patch of the present invention.

While various embodiments have been described, it is to be understood that variations and modifications can be resorted to as will be apparent to those skilled in the art. Such variations and modifications are to be considered within the purview and scope of the claims appended hereto.

1. A patch for a roofing membrane, which comprises
a substrate for application to the roofing membrane, with the substrate containing encapsulated adhesive on the side to be applied to the roofing membrane, and with the adhesive being encapsulated in rupturable cells which will rupture to release the adhesive when pressure is applied

2. The patch of claim 1, wherein the adhesive is encapsulated in multiple bubbles.

3. The patch of claim 1, wherein the adhesive is encapsulated in multiple ribbons.

4. The patch of claim 1, wherein the adhesive is encapsulated in multiple rupturable cells, with the adhesive being a two part adhesive requiring a first component and a second component to form the adhesive, and with some of the cells containing the first component and some of the cells containing the second component.

5. The patch of claim 4, wherein the cells are bubbles.

6. The patch of claim 4, wherein the cells are ribbon shaped.

7. The patch of claim 1, wherein the patch is rectangular in shape.

8. The patch of claim 7, wherein the patch is square.

9. The patch of claim 1, wherein the patch ha a hole in it which permits penetration of an extending member from the roof.

10. The patch of claim 9, wherein the hole allows penetration of a roof vent.

11. The patch of claim 1, wherein the patch is of an appropriate shape and size to fit over a seam or T-joint.

12. A method of applying a patch to a roofing membrane, which comprises
providing the patch of claim 1,
applying the patch to the desired portion of the roofing membrane, and
applying sufficient pressure to the patch to rupture the cells containing the adhesion to thereby release the adhesive.

13. The method of claim 12, wherein the pressure is applied with a roller.

14. The method of claim 12, wherein the pressure is applied by standing on the patch.

15. The method of claim 12, wherein the patch is cut to a desired size and shape.

16. The method of claim 12, wherein the patch is applied to a portion of the roofing membrane which has an extending membrane from the roof, and the patch allows for penetration of the extending member upon application.

17. The method of claim 12, wherein the cells containing the adhesive comprise bubbles.

18. The method of claim 12, wherein the cells containing the adhesive comprise ribbons.

19. The method of claim 12, wherein the roofing membrane is a single ply roofing membrane.

20. A roof assembly comprising a single ply roofing membrane which has applied to it the patch of claim 1.
